(19) United States
(12) Patent Application Publication
(10) Pub. No.: US 2009/0095075 A1
(43) Pub. Date: Apr. 16, 2009

(54) Sensor housing

(76) Inventors: Yevgeniy Vinshtok, Allentown, PA (US); Michael J. McGowan, Downingtown, PA (US); Peter Breh, West Chester, PA (US); Ralf Siegler, Schlier (DE)

Correspondence Address: CHRISTINE JOHNSON ESQ., 151 Trenton Rd., Fairless Hills, PA, 19030, US

(21) Appl. No.: 11/871,970

(22) Filed: Oct. 12, 2007

(51) Int. Cl. G01D 11/24

(52) U.S. Cl. 73/431

(57) ABSTRACT

A sensor housing (1) comprises at least one tube section (4; 9) which is formed of metallic glass.

This invention relates to a sensor housing comprising at least one tube section, and to a sensor device comprising such a housing.

In a sensor housing of the type known from U.S. Pat. No. 442,563 S or U.S. Pat. No. 470,462 S such a tube section can conventionally be used, for example, for the installation of the sensor housing into a carrier plate by pushing the thread-bearing tube section into a window of the carrier plate and fastening it with the aid of a screwed-on nut, and/or as a passage opening for a measuring signal which is to be recorded by a sensor element accommodated in the sensor housing.

To obtain a favorable ratio between the sensitivity of the sensor element and the space requirement of the sensor housing, it is desirable per se to minimize the wall thickness of the tube section. This objective cannot be optimally achieved with injection-molded plastic housings since quite a large wall thickness is required to impart to the housing the mechanical strength required for its fastening. By deep-drawing metal, it is actually possible per se to produce a thin-walled, solid tube section; yet, it cannot be provided with a thread as well. Metal casting techniques actually do allow the molding of a thread; however, they usually result in surfaces which must subsequently be smoothed if a seal is to fit tightly on them. In particular, if such a seal is to be effective between the inside surface of the tube section and an insert part inserted therein, the inside surface of the tube must be subsequently polished, or a groove accepting the seal must be machined on the tube's inside surface so that such housings are hardly economical.

To anchor a sensor housing of the above described type in a carrier plate in a twist-proof manner, the tube section must have a non-circular outside cross-section. However, a deviation of the free inside cross-section from the round form impairs its application potentials. Accordingly, the problem arises that it is, in fact, desirable on the one hand to keep the deviation of the outside cross-section from a round form as small as possible, but that the strain which the non-circular outside form is locally exposed to by an external torque is the greater, the smaller the deviation from the round form. Accordingly, to provide an effective torsional protection, the small deviation requires a high degree of strength and thus a large wall thickness of the tube section which, in turn, will be at the expense of the usable inside cross-section.

It is the object of this invention to remedy these problems of the state of the art.

To this end, it is proposed to form the tube section of metallic glass.

In recent years, metallic glasses have become known, also called amorphous alloys which—due to their non-crystalline structure—have a significantly greater hardness than crystalline alloys of similar composition. To obtain a solid body of metallic glass, a melt must be cooled down so fast that it solidifies before crystals are able to form. This prerequisite can be complied with during casting if the thickness of the cast part is not too large. Accordingly, metallic glasses ideally meet the requirement of great hardness with a small wall thickness. When casting conventional metals, crystals develop upon cooling down in the mold and result in a rough surface structure of the cast part even when the inside surfaces of the mold are polished. This does not happen with metallic glasses. Accordingly, and on the condition of a suitable surface quality of the mold, very smooth surfaces can be obtained when molding metallic glasses, and they are suitable—without re-machining—for sealing in contact with an elastic sealing ring.

To achieve a reliable sealing effect, the tube section should have at least locally, preferably on the inside, a surface roughness of less than Rz=6.3 μm, preferably 4.0 μm or below.

This can be achieved with metallic glass alloys on the basis of zirconium and titanium, and a high corrosion resistance is achieved in addition. Percentages of zirconium are preferred from 30 to 57 atomic percent and of titanium from 13 to 40 atomic percent. Additional alloy components may be copper, nickel, niobium, and/or beryllium. Particularly suitable are alloys with 40 to 42 atomic percent of zirconium, 13 to 15 atomic percent of titanium, 11 to 14 atomic percent of copper, 9 to 11 atomic percent of nickel, and 20 to 25 atomic percent of beryllium; or with 55 to 58 atomic percent of zirconium, 13 to 15 atomic percent of titanium, 6 to 8 atomic percent of copper, 4 to 7 atomic percent of nickel, 4 to 6 atomic percent of niobium, and 10 to 15 atomic percent of beryllium.

Molded parts from such alloys can reach a hardness of 380° Vickers or even 450° Vickers and more.

The first tube section is cylindrical in most applications.

On its circumference, the cylindrical tube section can be provided with at least one facet to form a torsional protection upon installation in a window of a carrier plate or the like.

The great hardness of the metallic glass enables an effective torsional protection even if the facet has a narrow width. Thus, the width of the facet can remain limited to under 40% of the diameter of the tube section, as compared to a ratio of typically approx. 50% for a plastic housing. Accordingly, the facet need not project deeply into the tube cross-section, and the maximum achievable inside cross-section is only slightly restricted by the facet.

For the installation in a window, the tube section can be expediently provided with an outside thread. In this case as well, a facet interrupting the outside thread in at least one place of the tube section can serve as a torsional protection. Another possible function of the facet results from the fact that such an outside thread is expediently molded with the aid of at least two molding tools which each extend, at maximum, over half of the circumference of the tube section. By placing the abutting surface between these molding tools each onto the facet or at least adjacent to it, it can be achieved that a molding seam resulting at the abutting surface of the molding tools does not impair the quality of the thread, or only slightly impairs it at best.

To entirely prevent any impairment of the thread by the molding seam, it is desirable that the facet intersects a core of the outside thread.

Since the molding seams normally form in pairs, the outside thread is expediently interrupted by recessed facets in at least two diametrically opposed places.

The metallic glass is also suitable for the manufacture of sensor housings in which the tube section has a rectangular cross-section.

The tube section has a wall thickness of under 0.7 mm and better yet of under 0.6 mm, preferably over its entire circumference, but at least locally if an outside thread exists, and, at least in the area of the facets if these exist.

An insert part accommodated in the tube section can be sealed by a sealing ring on an inside surface of the tube section. The inside surface of the tube section touched by the sealing ring is preferably planar in its longitudinal direction and, in particular, free of undercutting. It is thus possible to form the inside surface, including the area touched by the sealing ring, with the aid of a molding tool which must merely be pulled out of the tube section in longitudinal direction after solidification of the metallic glass.

An insert part accommodated in the tube section expediently comprises a transparent window for an interaction of a sensor element provided in the housing. In case of an inductive or capacitive sensor, this window can consist of any dielectric; in case of an optical or microwave sensor, it can preferably consist of a glass or plastic; and in the case of a magnetic sensor, this window can also consist of a non-magnetic metal, in addition to the above-mentioned possibilities.

Further, the insert part itself can be a condenser module of a capacitive sensor or a coil module of an inductive sensor; furthermore, it can also be a measuring stick of a filling level sensor.

Said tube section or a second tube section provided on the same sensor housing may also be used to accommodate—as an insert part—a bushing for an output signal, for a control signal, or for the operating energy of a sensor element provided in the housing.

At least on one end, the tube section can be connected in one piece with an end wall. The end wall may extend—from a circumferential wall of the tube section—radially to the inside to close off its interior; in this case, the interior of the sensor housing can be essentially defined by the interior of the tube section. However, it can also extend radially outwardly, for example, to form a mounting shoulder for the sensor housing, or to provide a transition to a second housing section.

In particular, the tube section may be merely an extension on a hollow basic body of the housing.

To simplify the manufacture of the tube section and the basic body in a molding process, the basic body can have a larger expansion in a first spatial direction orthogonal to the longitudinal direction of the tube section than in a second spatial direction which is orthogonal to the longitudinal direction and the first spatial direction; and facets formed on the tube section preferably extend in the second spatial direction to simplify a molding of the tube section and the basic body with the aid of molds movable in the second spatial direction.

When a second tube section provided with an outside thread extends from the basic body, the facets of the two tube sections expediently extend in a spatial direction which is orthogonal to the longitudinal axes of the two tube sections. This also serves to simplify the molding of the tube sections with the aid of molds movable in the spatial direction which is orthogonal to the longitudinal axes.

Further features and advantages of the invention will be apparent from the following description of exemplary embodiments, which refers to the enclosed figures. In the figures

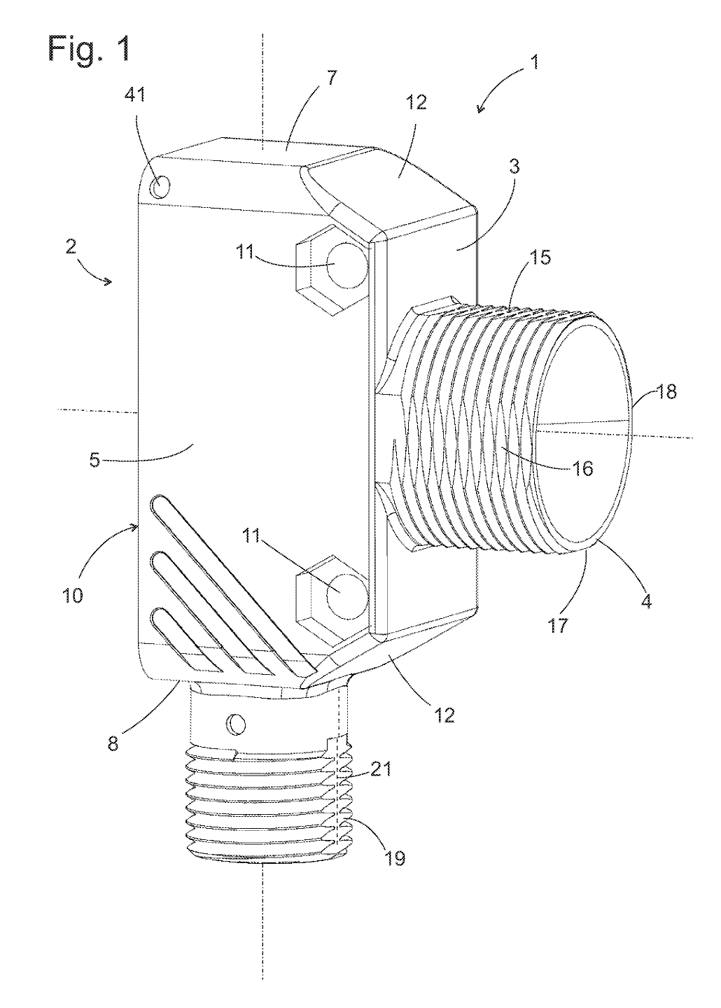

FIGS. 1, 2 and 3 each show perspective views of a sensor housing according to the invention;

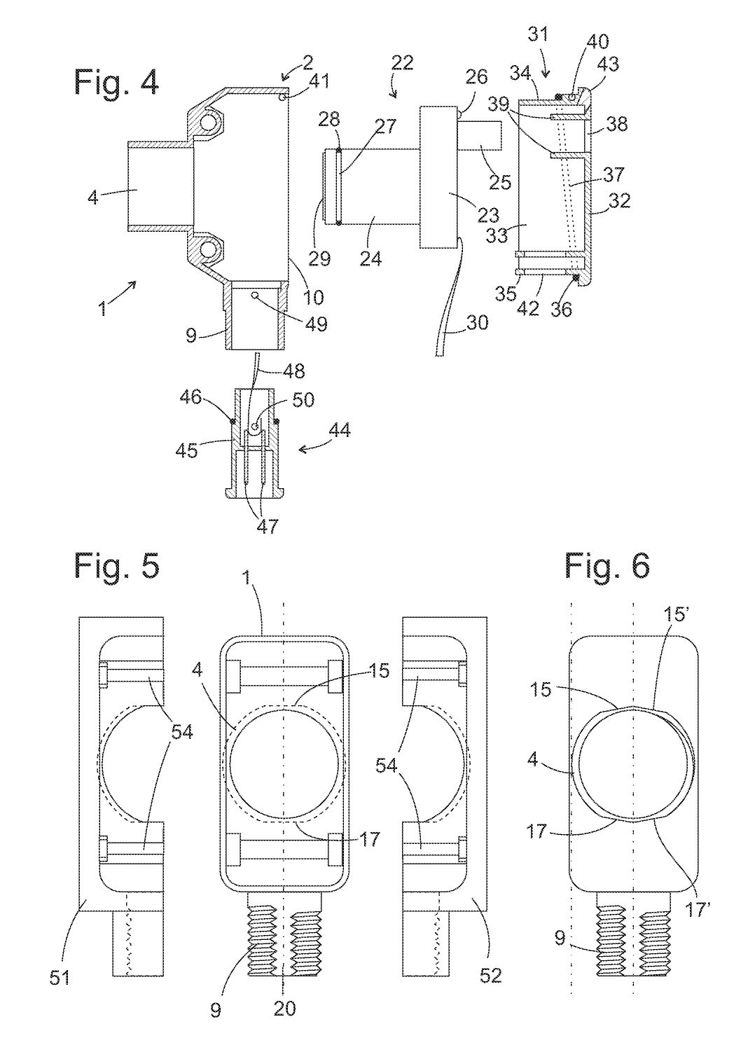

FIG. 4 shows an exploded section through the sensor housing, a sensor component intended for installation in the sensor housing, a cover, and a plug-in connector jack in an exploded view;

FIG. 5 a top view on the sensor housing and two molding elements used for its manufacture;

FIG. 6 a top view on the sensor housing according to a modified embodiment;

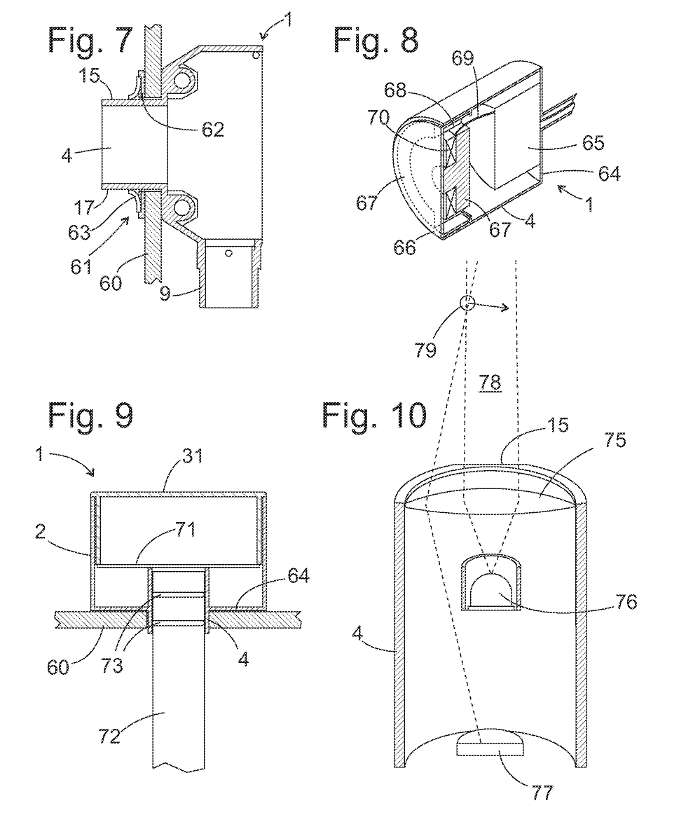

FIG. 7 a section analog to FIG. 4 through a sensor housing mounted on a carrier plate, according to a variant of the invention;

FIG. 8 an inductive proximity sensor in a perspective, cut-open view according to the invention;

FIG. 9 a diagrammatic section through a filling level sensor with a housing according to this invention; and

FIG. 10 an optical sensor with a housing according to this invention.

FIGS. 1 to 3 are each perspective views of one and the same sensor housing 1. The sensor housing 1 injection-molded from a metallic glass has an essentially cuboid basic body 2 with a front wall 3 from which centrally projects a tube section with outside thread, hereinafter also called threaded stub 4, longitudinal walls 5, 6 and transverse walls 7, 8, one of which—8—has a second threaded stub 9 whose diameter is smaller than that of threaded stub 4. One rear side 10 of the basic body 2 facing the front wall 3 is open. The basic body 2 can thus also be considered a tube section with a rectangular cross-section which is closed off at one end by the front wall 3. Two openings 11 for fastening screws extend above and below the threaded stub 4 between the longitudinal walls 5, 6. Deviating from an exact cuboid form of the basic body 2, two inclined facets 12 connect the front wall 3 with the transverse walls 7, 8.

On the outer circumference of the threaded stub 4 and at an angular distance of 90°, four planar facets 15 to 18 are formed, with the facets 15, 17 standing perpendicularly on one symmetry plane of the basic body 2 set by the longitudinal axes of the threaded stud 4, 9, and the facets 16, 18 extending parallel to it. When the threaded stub 4 is installed in a window of a carrier plate, the facets 15-18 effect a torsional protection. The width of the facets is each approx. 7 mm at a nominal thread diameter of 18 mm. Due to the great hardness of the metallic glass, these facets ensure torsional protection which is similarly effective as significantly broader facets with a conventional housing material. The narrow width is related to a relatively great distance between the paired, diametrically opposed facets 15, 17 or, respectively, 16, 18, allowing a large inside cross-section of the threaded stub 4.

Facets 16, 18 could also be omitted without crucially impairing the torsional protection.

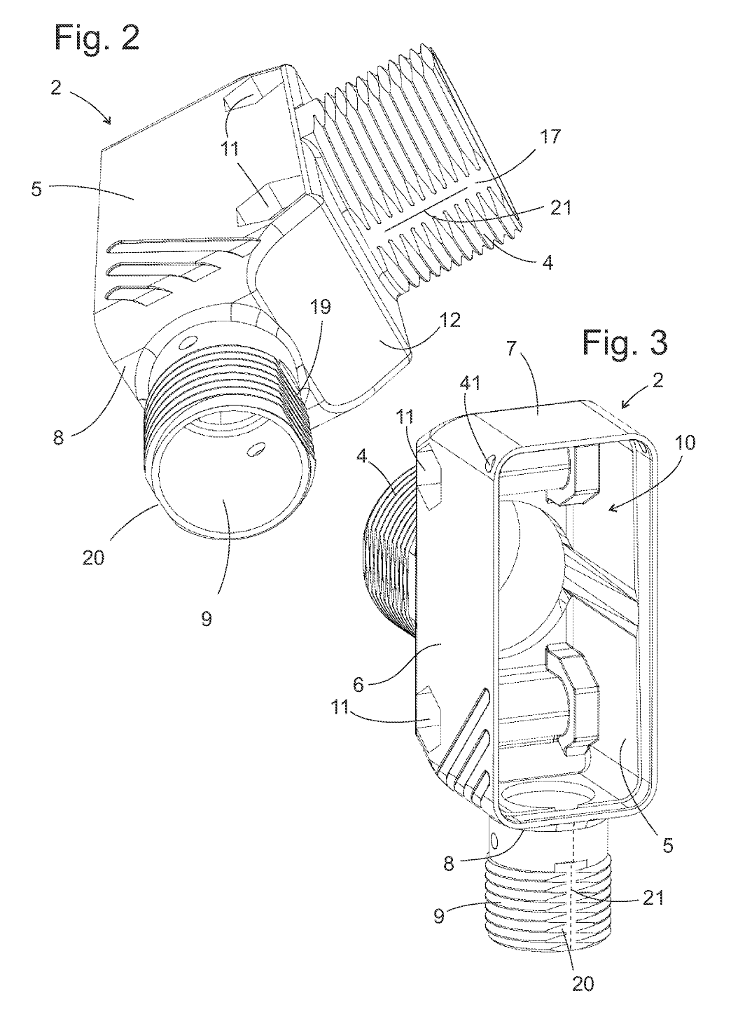

The threaded stub 9 comprises facets 19, 20 which are perpendicular to the symmetry plane. As to be seen, in particular, in a comparison of FIGS. 1 and 2, the facets 16, 18 parallel to the symmetry plane do not extend into the thread core of the threaded stub so that they consist of a plurality of individual planar surfaces on the individual teeth of the thread, whereas the facets 15, 17, 19, 20 perpendicular to the symmetry plane each extend into the thread core and thus form a planar surface continuously extending over the entire length of the threaded stub 4 or 9, respectively. Any molding seam 21 possibly extending on the facets 15, 17, 19, 20 due to a manufacturing inaccuracy can thus hardly come into contact with the inside thread of a nut (not shown) screwed onto the threaded stub 4 or 9, so that the thread teeth of threaded stub and nut engaging with each other will contact each other on a large surface, and the forces occurring on the thread are thus transmitted in a uniformly distributed way into the threaded stubs 4, 9.

FIG. 4 shows diagrammatically the structure of a complete sensor with the housing 1 shown in FIGS. 1 to 3. The housing 1 is provided to accommodate a sensor component 22 which here carries an approximately cuboid basic module 23, a cylindrical section 24 engaging in the threaded stub 4, as well as—on the rear side of the basis module 23 facing away from the cylindrical section—switches 25 and operating status indicator elements such as light-emitting diodes 26 for instance. At its end facing away from the basic module 23, the cylindrical section 24 has a circumferential groove 27 in which an O-ring 28 is accommodated. When the cylindrical section 24 is introduced into the threaded stub 4, the O-ring 28 seals on the inside area of the threaded stub 4.

The front face of the cylindrical section 24 is formed by a translucent window 29 behind which a photo diode is provided as a sensor element on the inside of section 24. Additionally, a light source, such as a light-emitting diode for instance, may be provided in the section 24 and emitting through the window 29 to the outside so that the photo diode detects light reflected from an object in front of the window 29. Of course, any other sensor elements such as capacitive or inductive proximity sensors for instance can be provided as sensor elements in the section 24; in this case, the housing up to the section 24 expediently consists of a dielectric or a non-ferromagnetic metal.

Signal and supply connections of the sensor component 22 extend on a flexible printed circuit board strip 30.

A cover 31 formed of plastic essentially comprises a plate 32 covering the open rear side 10 of the housing 1 and circumferential walls 33, 34, 35, extending along the walls of the plate 32. A window 38 in the plate 32 is limited by ribs 39 engaging between the walls 33. An opening 42 is formed in the lower wall 35. The lower wall 35 and one of the ribs 39 delimit a niche 53.

A shoulder 37 supporting a sealing ring 36 extends along the walls 33, 34, 35 in a plane oriented at an acute angle to the plate 32. The inclined orientation of the shoulder 35 allows to clip the cover 31 with the plate 32 oriented parallel to the rear side 10 onto the sensor housing 1 since the sealing ring 34 need not be pressed in over its entire length simultaneously between the walls 33, 34, 35 of the cover 31 and the walls 5 to 8 of the sensor housing 1.

When the cover 31 is pressed up to the stop onto the sensor housing 1, the ribs 39 touch the rear side of the basic module and thus fix it in position in the housing 1. The printed circuit board strip 30 is accommodated in the niche 53. A groove 40 of the cover 31 is in alignment with holes 41 in the longitudinal walls 5, 6 neighboring the transverse wall 7; and the opening 42 in the lower wall 35 is in alignment with the threaded stub 9. The switches 25 are inserted in the window 38 of the cover 31 and can be operated from the outside. The light-emitting diodes 26 are provided opposite a gap between the upper wall 34 and one of the ribs 39 so that they can illuminate a transparent insert 43 which forms an upper edge of the plate 32. An operating condition indicated by the light-emitting diodes 26 can thus be read off on the outside of the sensor housing 1.

A plug-in connector part 44 provided for insertion into the threaded stub 9 comprises an essentially cylindrical plastic body 45 which bears a sealing ring 46 on a shoulder and into which contact pins 47 are inserted. The contact pins 47 are connected with conductors of a flexible printed circuit board strip 48.

After the assembly of housing 1, sensor element 22 and cover 31, the free end of the printed circuit board strip 30 is first pulled out through the opening 42 and the threaded stub 9 and then contacted with the printed circuit board strip 48. Subsequently, the plastic body 45 is inserted into the threaded stub 9 with the sealing ring 46 sealing on the inside of the threaded stub 9. The plastic body 45 here engages into the opening 42 of the wall 35 of the cover 31 and interlocks it.

Complete interlocking and fixation of the cover 31 is achieved by inserting pins (not shown) through the holes 41 of the sensor housing 1 into the groove 40 of the cover 31. For fixation of the plastic body 45, short bolts can, moreover, be pressed into holes 49 of the threaded stub 9 and depressions 50 of the plastic body 45 which are aligned with them.

FIG. 5 illustrates diagrammatically the manufacture of the sensor housing 1. The sensor housing 1 is seen in a top view onto its open rear side; to the right and left thereof, two parts 51, 52 of a mold used for manufacture are to be seen. The pins 54 forming the passages 11 determine the direction of movement of the molded parts 51, 52 upon removal of the mold. The mold parts 51, 52 touch each other during molding along the symmetry plane of the basic body 2 so that molding seams can develop on the threaded stubs 4, 9 only in this symmetry plane, on the facets 15, 17, 19, 20.

For molding the sensor housing 1, alloys on the basis of zirconium and titanium are used which are sold by Liquidmetal Technologies, Inc., Lake Forest, Calif., U.S.A. under the designations of Liquidmetal I Alloy and Liquidmetal II Alloy. Suitable alloys are, in particular, Zr_{41,2}Ti_{13,8}Cu_{12,5}Ni₁₀Be_{22,5} and Zr_{56,2}Ti_{13,8}Nb_{5,0}Cu_{6,9}Ni_{5,6}Be_{12,5}. When heated, these alloys have the special feature of forming a melt of a temperature-dependent viscosity and, when cooled down sufficiently fast, an amorphous solid body of great hardness is formed from the melt. The amorphous, glassy nature of the solid body results in the molded housing being virtually free from the crystallization-specific grainy surface structure typical for metal castings, so that the finished molded body can be removed from the mold with a surface roughness of less than Rz=5.3 μm. When these alloys are used, a wall thickness of 0.5 mm is sufficient for the walls 5 to 8 of the basic body 2, with the edge lengths of the walls between 15 and 50 mm. At their thinnest point, the facets 15, 17, 19, 20 each have a wall thickness of 0.55 mm or less.

FIG. 6 shows a top view onto the front wall 3 of a sensor housing in accordance with a slightly modified embodiment of the invention. In this modification, facets 15, 15′ or, respectively, 17, 17′ are each molded on the threaded stub 4 on both sides of the symmetry plane and meet at a very obtuse angle at the symmetry plane. The facets 15, 17 are molded by a same molded part, the facets 15′, 17′ by another. The non-parallelism of the facets 15 and 17 or, respectively, 15′ and 17′ facilitates the removal of the finished housing from the mold; otherwise, this embodiment essentially has the same effects and advantages as the one described with reference to the FIGS. 1 to 5.

FIG. 7 shows a section through a sensor housing 1 according to a variant of the invention, mounted in an opening of a carrier plate 60. The tube section 4 of the housing 1 inserted into the carrier plate 60 has only two diametrically opposed facets 15, 17, as also shown in FIG. 5. To keep the sensor housing 1 twist-proof, the opening of the carrier plate 60 also has the form of a circle, reduced by two diametrically opposed segments which are complementary to the facets 15, 17. The tube section 4 is thread-free and is held on the plate 60 with the aid of a slipped-on ring 61. The ring 61 has a rigid base plate 62 and an elastic lip 63 circumferentially fastened thereon. A central opening of the lip 63 is smaller than the diameter of the tube section 4 so that the lip 63 is distorted when it is set on, and it is pressed from the outside against the tube section 4. Any retraction of the sensor housing 1 from the carrier plate 60 would result in an increased deflection of the lip 63 which the lip 63 resists.

Cut open along a symmetry plane, FIG. 8 shows an inductive proximity sensor as another exemplary embodiment of the invention. A housing 1 molded from glass metal essentially comprises a cylindrical tube section 4 which is closed at one end by an end wall 64 forming one part with it. The cup-like hollow form thus created accommodates an analysis circuit 65 not shown in detail which is connected with a sensor element filling up the open front side of the housing 1. Shielded from the surroundings by a cover 66 engaging into the housing 1, the sensor element comprises a flat-cylinder ferrite core 67 on the front side of which an annular groove is formed, and a coil 70 inserted into the annular groove and connected with the analysis circuit 64 via cables 69 extending through a slot 68 of the ferrite core 67. Since, in the embodiment shown here, the housing 1 extends alongside around the ferrite core 67 up to its front side, it functions at the same time as a shield which limits the magnetic field of the coil 70 to the space directly in front of the sensor housing 1. Embodiments are also possible, of course, wherein the coil 70 projects from the housing 1 of amorphous metal and thereby generates a magnetic field also extending in radial direction.

In a manner known per se, the inductive proximity sensor shown can also be further developed to a magnetic field sensor by providing, adjacent to the coil 70, a body of a soft-magnetic material which dampens the coil 70. The soft-magnetic body may be, for example, a solid soft-magnetic body provided in the tube section 4 adjacent to the ferrite core 67, or it may be a soft-magnetic coating on the tube section 4 or, if the material is suitably selected, it may be the tube section 4 itself.

FIG. 9 shows a diagrammatic section through a filling level sensor with a housing 1 pursuant to this invention. The housing 1 has a substantially cuboid basic body 2 which can be conceived of as a tube section open on the top and closed off on the bottom in one piece by an end wall 64. A cylindrical tube section 4 projects from the end wall 64. One part of the tube section 4 extending into the interior of the basic body 2 fixes in place—together with a cover 31 engaging from above—a printed circuit board 71 which bears an analysis circuit of the sensor. A lower part of the tube section 4 penetrates a wall 60 of a vessel whose filling level is to be monitored.

A measuring stick 72 is pushed from the bottom into the tube section 4 and is tightly fixed therein with the aid of sealing rings 73 anchored in grooves of the measuring stick 72, or by bonding, or in another manner. The interior structure of the measuring stick 72 not shown in the Figure depends on the technology known per se which is used for the measurement. In case of a capacitive filling level sensor, condenser plates in the form of electrically conductive films are arranged axially staggered on the inside of a cylindrical exterior sheath of the measuring stick 72; and the mode of operation of the measuring circuit is based on the capacity of the condensers—each formed by one of the condenser plates and a vessel receiving the filling level sensor—depending on the presence or absence of a medium to be recorded in the vessel. To obtain a strong measuring signal which can be analyzed well, it is desirable to make the condenser plates large-sized, and the prerequisite for it is a large diameter of the measuring stick 72. Yet, to be able to mount the condenser plates, the diameter of the measuring stick should be nowhere larger than in its area held in the tube section 4. Accordingly, a large inside diameter of the tube section 4 is desirable. To achieve this with the given dimensions of the vessel opening, it is expedient when at least the tube section 4, preferably the entire sensor housing 1, is manufactured of the above-mentioned glass metal alloys which have a high strength at low wall thicknesses.

Similar considerations apply for filling level sensors which operate according to other principles, for example those in which sender and receiver for an acoustic or electromagnetic oscillation are accommodated in the sensor housing 1, the sender emitting the oscillation into the measuring stick which functions as a filling-level dependent, loss-prone waveguide for the oscillation, and a filling-level dependent, dampened echo of the oscillation is recorded by the receiver.

One example of an optical sensor is shown in a cross-section in FIG. 10. The tube section shown cut open in the Figure may be the tube section 4 of a housing of the type shown in FIGS. 1 to 3 or that of the cup-like housing of FIG. 8. One end of the tube section 4 is tightly closed by a focusing lens 75. A light source 76, such as a light-emitting diode for instance, and a light sensor element 77, for example a photo diode, are lying one after the other on the optical axis of the focusing lens 75. The lens 75 bundles the light from the source 76 to a beam 78. When an object 79 to be registered gets into the beam 78, it reflects light back to the lens 75. Only when the reflecting object 79 lies within a range of distance in front of the lens 75 defined by the focal length of the lens 75 and the inner geometry of the sensor, the light reflected to the lens impinges on the sensor element 77. Due to the exactly axial-symmetric structure of the sensor of FIG. 10, the object 79 is registered independent of whether it is diffusely reflective and illuminates the entire surface of the focusing lens 75, or whether it has mirroring surfaces which each reflects light only on one part of the lens surface. With given outside dimensions of the tube section 4 and despite the possible presence of a twist-proof facet 15, the use of metallic glass for the tube section 4 here again renders possible a large free cross-section of the tube section 4 and thus a high sensitivity of the sensor.

1. Sensor housing (1) comprising at least one first tube section (4; 9), characterized in that the tube section (4; 9) is molded of metallic glass.

2. Sensor housing according to claim 1, characterized in that the metallic glass is an alloy on the basis of titanium and zirconium.

3. Sensor housing according to claim 2, characterized in that the alloy comprises from 30 to 57 atomic percent of zirconium and from 5 to 60 atomic percent of titanium.

4. Sensor housing according to claim 2, characterized in that the metallic glass comprises one alloy component or a plurality of alloy components selected from among copper, nickel, niobium, beryllium.

5. Sensor housing according to claim 2, characterized in that the metallic glass contains from 40 to 42 atomic percent of zirconium, from 13 to 15 atomic percent of titanium, from 11 to 14 atomic percent of copper, from 9 to 11 atomic percent of nickel and from 20 to 25 atomic percent of beryllium.

6. Sensor housing according to claim 2, characterized in that the metallic glass contains from 55 to 58 atomic percent of zirconium, from 13 to 15 atomic percent of titanium, from 6 to 8 atomic percent of copper, from 4 to 7 atomic percent of nickel, from 4 to 6 atomic percent of niobium, and from 10 to 15 atomic percent of beryllium.

7. Sensor housing according to claim 1, characterized in that at least the first tube section (4; 9) has a hardness of at least 380° Vickers, preferably at least 450° Vickers.

8. Sensor housing according to claim 1, characterized in that the first tube section (4; 9) has at least locally a surface roughness of less than Rz=6.3 μm, preferably of not more than Rz=4.0 μm.

9. Sensor housing according to claim 1, characterized in that the first tube section (4; 9) is cylindrical.

10. Sensor housing according to claim 9, characterized in that at least one facet (15-20) is formed on the circumference of the tube section (4; 9).

11. Sensor housing according to claim 9, characterized in that the tube section (4; 9) has an outside thread.

12. Sensor housing according to claim 11, characterized in that the outside thread is interrupted in at least one place of the circumference of the tube section (4; 9) by a facet (15-20).

13. Sensor housing according to claim 12, characterized in that the facet (15-20) intersects a core of the outside thread.

14. Sensor housing according to claim 12, characterized in that the outside thread is interrupted in at least two diametrically opposed places by recessed facets (15, 17; 19, 20).

15. Sensor housing according to claim 12, characterized in that the width of the facet (15-20) is less than 45% of the diameter of the tube section (4; 9).

16. Sensor housing according to claim 1, characterized in that the tube section (2) has a rectangular cross-section.

17. Sensor housing according to claim 1, characterized in that the tube section (2; 4; 9) has at least locally a wall thickness of under 0.7 mm, preferably under 0.6 mm.

18. Sensor housing according to claim 1, characterized in that an insert part (31; 24; 44; 72) accommodated in the tube section (2; 4; 9) is sealed on an inside surface of the tube section (2; 4; 9) by a sealing ring (28; 36; 46; 73).

19. Sensor housing according to claim 18, characterized in that the inside area of the tube section (2; 4; 9) touched by the sealing ring (28; 36; 46; 73) is planar in its longitudinal direction.

20. Sensor housing according to claim 1, characterized in that the tube section (2; 4) is connected in one piece on at least one end with an end wall (3; 64).

21. Sensor housing according to claim 1, characterized in that the tube section (4; 9) extends from a hollow basic body (2) of the housing (1).

22. Sensor housing according to claim 21, characterized in that the basic body (2) is closed by a cover (31) on one side facing away from the first tube section (4).

23. Sensor housing according to claim 21, characterized in that the basic body (2) has a greater expansion in a first spatial direction orthogonal to the longitudinal direction of the tube section (4; 9) than in a second spatial direction which is orthogonal to the longitudinal direction and the first spatial direction, and that facets (15, 17, 19, 20) extend in the second spatial direction which are formed on the tube section (4; 9).

24. Sensor housing according to claim 21, characterized in that a second tube section (9; 4) provided with an outside thread extends from the basic body (2), and that facets (15, 17, 19, 20) of the two tube sections (9; 4) extend in a spatial direction which is orthogonal to the longitudinal axes of the two tube sections (9; 4).

25. Sensor device with a sensor housing according to claim 1 and at least one sensor element and/or an analysis circuit for a sensor signal in the interior of the sensor housing.

26. Sensor device according to claim 25, characterized in that an insert part (24) accommodated in the tube section (4) comprises a window (29; 66; 75) which is transparent for an interaction of the sensor element provided in the housing.

27. Sensor device according to claim 25, characterized in that an insert part accommodated in the tube section (4) is a measuring stick (72) of a filling level sensor, a condenser module of a capacitive sensor, or a coil module (67,70) of an inductive sensor.

28. Sensor device according to claim 25, characterized in that an insert part (44) accommodated in the tube section (9) comprises a leadthrough for an output signal, for a control signal, or for the operating energy of the sensor element (22) and/or the analysis circuit.
